(19) United States
(12) Patent Application Publication
(10) Pub. No.: US 2024/0368012 A1
(43) Pub. Date: Nov. 7, 2024

(54) DEVICES, SYSTEMS, AND METHODS TO FACILITATE CRITICAL METAL EXTRACTION FROM WATER

(71) Applicant: Katz Water Tech, LLC, Houston, TX (US)

(72) Inventors: Michael Raymond Pavia, Houston, TX (US); James Clarke, Houston, TX (US); Gary Katz, Houston, TX (US)

(73) Assignee: Katz Water Tech, LLC, Houston, TX (US)

(21) Appl. No.: 18/387,850

(22) Filed: Nov. 7, 2023

Related U.S. Application Data
(60) Provisional application No. 63/423,458, filed on Nov. 7, 2022.

(51) Int. Cl. C02F 3/00; C02F 101/10

(52) U.S. Cl. CPC C02F 3/006; C02F 2101/10; C02F 2209/005

(57) ABSTRACT

A device, system, process, and method for extracting metals from contaminated fluid comprising a pretreatment stage, a biosorption column, a thermal dewatering processes, and at least one chemical precipitation step. The biosorption process typically involves at least one fixed bed column wherein metals are reversibly adsorbed to immobilized biomass and eluted with a caustic solution. Treated effluent is further processed via thermal dewatering and chemical precipitation. The process can be used to simultaneously purify industrial wastewater for reuse while extracting valuable metals.

### CROSS REFERENCE TO RELATED APPLICATION

This non-provisional patent application claims priority to co-pending U.S. Provisional Patent Application No. 63/423,458 entitled, “DEVICES, SYSTEMS, AND METHODS TO FACILITATE CRITICAL METAL EXTRACTION FROM WATER” filed on Nov. 7, 2022 with confirmation number 7046. U.S. Provisional Patent Application No. 63/423,458 is hereby incorporated by reference in its entirety.

### TECHNICAL FIELD

The present disclosure generally relates to the field of water treatment. The invention relates to processes and methods for selectively removing metal ions from industrial wastewater. In particular, the invention relates to the synergistic use of biosorption and thermal dewatering to extract metals from contaminated water. Most particular, the invention relates to the synergistic use of biosorption, membranes and thermal dewatering to extract critical metals such as, lithium, rare earth elements, cobalt, nickel, and rare earth elements from contaminated water.

### BACKGROUND

This section is intended to introduce the reader to various aspects of art, which may be associated with embodiments of the present invention. This discussion is believed to be helpful in providing the reader with information to facilitate a better understanding of techniques of the present invention. Accordingly, these statements are to be read in this light, and not necessarily as admissions of prior art.

In 2017, the White House introduced Executive Order 13817, acknowledging the strategic vulnerability of U.S. import reliance on critical minerals and materials (CMMs). Since then, the Department of the Interior (DOI) has published a list of 35 CMMs, essential to domestic energy, climate, and technology goals. The final list includes: Aluminum (bauxite), antimony, arsenic, barite, beryllium, bismuth, cesium, chromium, cobalt, fluorspar, gallium, germanium, graphite (natural), hafnium, helium, indium, lithium, magnesium, manganese, niobium, platinum group metals, potash, the rare earth elements group, rhenium, rubidium, scandium, strontium, tantalum, tellurium, tin, titanium, tungsten, uranium, vanadium, and zirconium. However, CMMs, including Li, Co, Mg, Cr, and others, are rare in the US, and thus will need to be extracted economically from low-quality resources. Additional elements not listed can also be targeted, as needed, for beneficial recovery.

Several critical materials including rare earth elements and lithium are currently fundamental to emerging green energy technologies in the United States (e.g., permanent magnet motors for wind turbines and disk drives, hybrid car batteries, compact fluorescent lighting, and/or displays in all types of consumer/defense electronics), as well as other uses such as industrial catalysts for refining heavier crude oil, automobile catalytic converters, and/or as alloying elements. Presently, lithium and rare earth elements can be obtained through solar evaporation ponds and mining, both of which are expensive and have numerous environmental issues.

Population growth, climate change, and industrialization have led to increased global water scarcity. Additionally, growth in technology sectors, especially those associated with electrification, has stressed the supply chains of certain valuable metals.

Energy, mining, and other industries produce enormous quantities of wastewater, which cannot be easily disposed of and requires specialized treatment to remove toxic metal ions. However, both the water and metals in wastewater are valuable natural resources that can be extracted. Existing solutions including precipitation, ion-exchange, electrolysis, and filtration suffer from certain shortcomings as: high cost, low capacity, and increased complexity. Additionally, these solutions do not inherently enable beneficial reuse of dissolved metal ions. The effect of these limitations is to prevent beneficial reuse of industrial wastewaters.

Currently, the most effective processes for wastewater treatment are thermal dewatering, also known as thermal distillation (“TD”), and membrane filtration via reverse osmosis (“RO”). These processes can produce fresh water from wastewater, but both require high energy input and are plagued with capital cost limitations and issues with scaling or fouling. Equipment for thermal energy recovery and mechanical energy recovery exist, but the complexity of such equipment drives up costs and limits the impact of RO and TD. For many wastewaters, the most common end-of-life (“EOL”) strategies comprise of discharge and injection. As even the best available technology does not allow for simultaneous recovery of both water and valuable metals in an economic manner, there is a need for new technology.

The rising need for lithium for its extensive application in rechargeable batteries to power electronics and automobiles is well documented in the art. See Meshram, Pratima, B.d. Pandey, and T.r. Mankhand. “Extraction of lithium from primary and secondary sources by pre-treatment, leaching and separation: A comprehensive review.” Hydrometallurgy 150 (2014): 192-208, the disclosure of which is incorporated herein by reference. Traditionally, technologies for lithium extraction involve solvent extraction from minerals and concentration from salt-lake deposits through evaporation, however, limited resources, long processing times and elevated costs pose a substantial challenge to meet its ever-increasing global demand. See Mohr, Steve H., Gavinm. Mudd, and Damien Giurco. “Lithium Resources and Production: Critical Assessment and Global Projections.” Minerals2.4 (2012): 65-84, the disclosure of which is incorporated herein by reference.

More recent, alternative sources for lithium include recovery from produced water that is readily available as a byproduct of oil field operations. See McEachern, Preston, MGX Minerals 2017, Report, “Lithium Recovery from Oilfield Produced Water Brine & Wastewater Treatment” the disclosure of which is incorporated herein by reference. The success and economic feasibility of lithium extraction from these sources using available techniques is highly dependent on initial processing of the water to remove emulsified oil, hydrogen sulfide, divalent cations and total organic carbon content.

Existing methods for removing metal ions from aqueous solution include chemical precipitation, ion exchange, electrochemical treatment, and membrane technologies. However, each of these methods suffer from serious limitations, including low efficiency, high cost, and environmental concerns. As such, these methods are not suitable for large scale commercial recovery of metals in wastewaters.

In the past it was not economical to extract products from industrial waste streams such as produced water. The costs involved include infrastructure and operational costs to collect the water, transport the water, concentrate the water for metal removal, and then selectively remove the valuable components. Therefore, any selective removal process cannot be economical unless there is an economical way to collect, transport and concentrate the metals.

Accordingly, there is a need for a low-cost method to remove valuable critical materials from industrial wastewater sources. These sources include wastewater from mining, chemical processing, and oil production operations. The embodiments of the intention disclosed herein solves this need.

### BRIEF SUMMARY

The present disclosure is directed to devices, systems, and methods for removing at least one critical material from water. Embodiments of the present disclosure are also directed to devices, systems, and methods for purifying industrial wastewater stream while removing at least one critical material, ion, or salt.

Embodiments of the invention include a device. In one embodiment, the device comprises at least one pretreatment system, wherein the at least one pretreatment system removes at least one contaminant from a water stream; at least one biosorption column; wherein the biosorption column adsorbs at least one metal from the water stream; at least one thermal dewatering system, wherein the at least one thermal dewatering system removes at least a portion of the water from the water stream; and at least one chemical precipitation system where the chemical precipitation system removes at least one metal that was removed from the water stream using the at least one biosorption device or column.

Embodiments of the invention include a system. In one embodiment, the system comprises at least one pretreatment system, wherein the at least one pretreatment system removes at least one contaminant from a water stream; at least one biosorption column; wherein the biosorption column adsorbs at least one metal from the water stream; at least one thermal dewatering system, wherein the at least one thermal dewatering system removes at least a portion of the water from the water stream; at least one chemical precipitation system where the chemical precipitation system removes at least one metal that was removed from the water stream using the at least one biosorption column; and at least one control panel that runs the at least one biosorption column and the at least one chemical precipitation system in a coordinated manner.

Embodiments of the invention include a method. In one embodiment, the method steps comprise introducing a water stream into a device; removing at least one contaminant from the water stream using a pretreatment system connected to the device; removing at least one metal from the water stream using biosorption; removing at least a portion of the water from the water stream using a thermal dewatering system; and precipitating out the at least one metal removed from the water stream using biosorption using a chemical precipitation method.

### BRIEF DESCRIPTION OF THE DRAWINGS

For a more complete understanding of the disclosed methods and apparatuses, reference should be made to the embodiments illustrated in greater detail in the accompanying drawings, wherein:

FIG. 1a is a detailed section view of an evaporator system;

FIG. 1b is a top view of the evaporator system of FIG. 1a;

FIG. 1c is a bottom view of the evaporator system of FIG. 1a;

FIG. 2 is a detailed profile view of a solar evaporator system;

FIG. 3 shows a detailed profile of a skid system that uses alternative heat energy;

FIG. 4 is a detailed view of a geothermal evaporator system at the surface of a geothermal well;

FIG. 5 is a flow chart showing a lithium removal method embodiment of this invention;

FIG. 6 is a flow diagram of a potential process embodiment of this invention;

FIG. 7 is a detailed view of a possible biosorption column;

FIG. 8 is a flow chart showing the process steps in one embodiment;

FIG. 9 is a flow diagram of an additional process embodiment of this invention;

FIG. 10 is an alternate schematic depicting the steps involved in an embodiment suitable for field deployment.

FIG. 12 is a schematic showing the use of constant-stirred tank reactors;

FIG. 13 is a process flow diagram illustrating the removal of lithium from produced water; and

FIG. 14 is a simple schematic showing the location of sensors for a control system;

FIG. 15 is a flow chart showing a membrane-based embodiment method for critical material removal; and

FIG. 16 is a flow chart showing a combined microbial and membrane-based embodiment method for critical material removal; and

The drawings are not necessarily to scale and that the disclosed embodiments are sometimes illustrated diagrammatically and in partial views. In certain instances, details which are not necessary for an understanding of the disclosed methods and apparatuses, or which render other details difficult to perceive may have been omitted. It should be understood, of course, that this disclosure is not limited to any specific embodiment illustrated herein.

### DETAILED DESCRIPTION

Below is a description of various embodiments of the invention. Before describing selected embodiments of the present disclosure in detail, it is to be understood that the present invention is not limited to any specific embodiment described herein. The disclosure and description herein are illustrative and explanatory of one or more presently preferred embodiments and variations thereof. It will be appreciated by those skilled in the art that various changes in the design, organization, means of operation, structures and location, methodology, and use of mechanical equivalents may be made without departing from the spirit of the invention.

The drawings are intended to illustrate and plainly disclose presently preferred embodiments to one of skill in the art. The drawings are not intended to be manufacturing level drawings or renditions of final products. These may include simplified conceptual views to facilitate understanding or explanation. In addition, the relative size and arrangement of the components may differ from that shown and still operate within the spirit of the invention.

Moreover, various directions such as “upper”, “lower”, “bottom”, “top”, “left”, “right”, “first”, “second” and so forth are made only with respect to explanation in conjunction with the drawings. The inventive components may be oriented differently, for instance, during transportation, manufacturing and operations. Numerous varying and different embodiments and modifications may be made within the scope of the concept(s) embodiments herein taught and described. Therefore, it is to be understood that the details herein are to be interpreted as illustrative and non-limiting. For example, many embodiments and examples are used to describe treating industrial wastewater including produced water, mine water, and chemical processing plant water. However, the invention can be used to handle any type of water stream or wastewater.

In varying embodiments, the water may or may not need pretreatment to remove one or more contaminants. Examples of suitable pretreatment systems and methods are described in detail in U.S. Pat. No. 10,864,482 issued on Dec. 15, 2020 and U.S. Pat. No. 10,968,126 issued on Apr. 6, 2021. Both U.S. Pat. No. 10,864,482 and U.S. Pat. No. 10,968,126 are hereby incorporated by reference. The filtration devices and/or system can utilize known filters and pumps in a specific orientation to achieve preferred operation conditions. For example, U.S. Patent application No. 2011/0120928 disclosed the benefit of combining known different types of pre-filtering devices before running water through the reverse osmosis membranes. U.S. Patent application No. 2011/0120928 is hereby incorporated by reference.

In most embodiments, unless the concentrations of the desired materials or critical materials are sufficiently high, the water will need undergo a dewatering process using a system to concentrate the metal or metals of interest. This process typically increases the metals of interest by removing significant amounts of water of at least 50 percent or more or removing all excess water to get to a supersaturated state or solid. Examples of dewatering include thermal distillation, dehumidification, and membrane separation. While all dewatering systems can be used in embodiments of the invention, thermal dewatering, typical thermal desalination, or thermal distillation with energy capture is typically the most economical approach. Examples of thermal dewatering systems or methods, especially thermal distillation can be found in U.S. Pat. No. 11,034,605 issued on Jun. 15, 2021. U.S. Pat. No. 11,034,605 is hereby incorporated by reference.

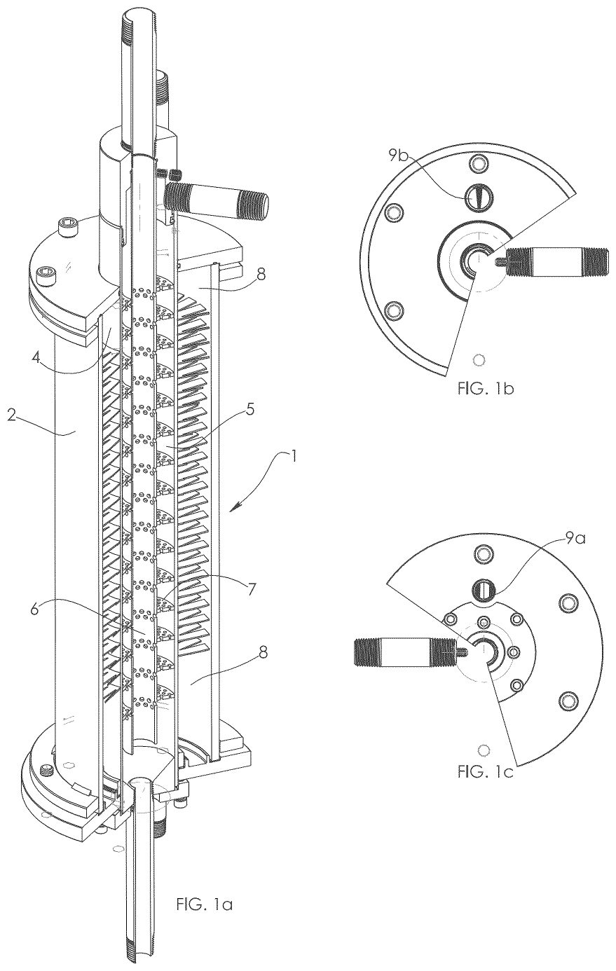

In one embodiment, as shown in FIG. 1a, the evaporator 1 utilizes a commercially available finned tube heat exchanger 4 housed within an outer housing 2. The housing is preferably made from metal and even more preferably made from stainless steel. Insulation (not shown) can be added to the inside of the housing, outside of the housing and both the inside and outside of the housing as needed. The types of insulation used can include but are not limited to ceramic insulation, paint insulation, coatings, foam, and combinations thereof. Within the inner annulus 5, or vertical run of this finned tube 4, an additional perforated evaporation column 6 is inserted along with an internal spring (not shown) that serves a water tray or water carrier. The inner annulus 5 is preferably fluidly isolated from the outermost annulus 8 by any appropriate method known in the art including elastomer seals or gaskets. The internal spring is described in U.S. patent application Ser. No. 17/506,661 entitled “COILED SPRING” that was filed on Oct. 20, 2021. U.S. patent application Ser. No. 17/506,661 is hereby incorporated by references in its entirety. Alternatively, perforated conical washers 7 can be welded to the outside of the evaporation column 6.

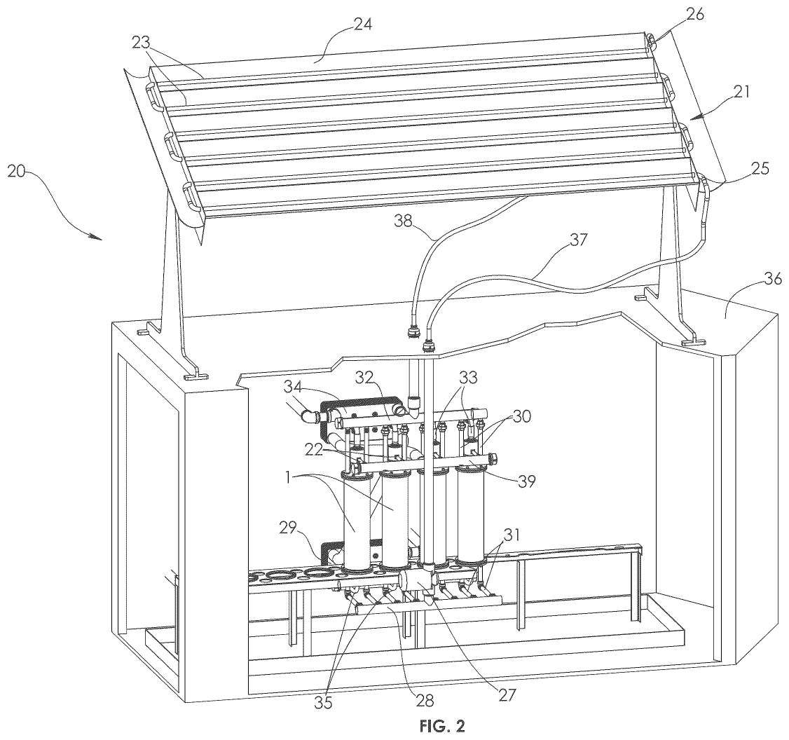

Evaporators using solar, geothermal and waste heat energy are described in U.S. Provisional Patent Application No. 63/317,046. U.S. U.S. Provisional Patent Application No. 63/317,046 is hereby incorporated by reference. In one embodiment, a solar evaporator system 20 shown in FIG. 2 utilizes heat supplied by the sun to heat a thermal transfer fluid which is transferred to a heat exchanger 4 shown in FIG. 1a of an evaporator system 1, as shown in FIG. 2. In a preferred embodiment, solar transfer fluid is heated by an external linear solar reflector panel system 21. These reflectors 24 focus the sun's heat radiation on conduit 23 filled with the transfer fluid. In one embodiment, several linear parabolic panel reflectors 24 could be connected in series where the fluid continues flowing from an inlet 25 of the solar panel conduit to an outlet 26 of the solar panel conduit. As the transfer fluid flows from the inlet 25 to the outlet 26, the fluid continues to increase in temperature as it progresses through the panel conduit 23. The solar panels 21 could also be connected in parallel to increase the total available volume of heat transfer fluid. In another preferred embodiment, the solar transfer fluid could be heated by a parabolic dish (not shown) where the sun's heat radiation is concentrated into a single focal area. The temperature of the focal area of the parabolic dish is generally much higher than the focal point of linear solar reflectors 24.

In a preferred embodiment, the solar evaporator system 20 is transported to a location on a trailer 36 but could be transported on a skid on the bed of a truck or in a shipping container. The system 20 could be unassembled and transported to a location and assembled there. In one embodiment, the solar system 20 has a pump 27 to circulate the thermal fluid through the conduit 23 and through the evaporator system 1 once heated. In a preferred embodiment, the solar system 20 has adjacently located heat exchangers 29 and 34 to recapture the heat energy exiting the system 1 namely the unevaporated processed water called brine and the evaporate steam to preheat the produced water entering the system 20. In one embodiment, the solar system 20 has more than one evaporator 1 connected in parallel. In a Multi-effect distillation (“MED”) system, pressure energy can also be recaptured.

Heated thermal transfer fluid exits the solar panels 21 at outlet 26 and travels through supply conduit 38 or piped or pumped into supply manifold 32. Supply manifold 32 has outlets 30 that could supply each evaporator 1 with heated thermal transfer fluid at opening 9a as shown in FIG. 1b. In another embodiment there could be more than one supply manifold in the solar system 20. In another embodiment, the cooled thermal transfer fluid exits the evaporator 1 at opening 9b shown in FIG. 1c to enter return manifold 28 by exit conduits 31 as shown in FIG. 2. In one embodiment, return manifold 28 could accept the transfer fluid exiting all evaporators in the solar system 20 or in another embodiment there could be multiple return manifolds. The cooled thermal transfer fluid exits the supply manifold and is pumped back through return conduit 37 or pipe by circulation pump 27.

In a preferred embodiment, the produced water enters the solar evaporator system 20 shown in FIG. 2 and is preheated by pre-warmer heat exchangers 29 and 34 using waste heat energy from the steam evaporate and unevaporated brine. The pre-heated produced water enters a produced water manifold 39. The manifold 39 has outlets 22 which supplies one or more evaporators 1 with water to be processed and enters the innermost annulus 5 as shown in FIG. 1a. In a preferred embodiment the solar system has one manifold 39 but the system 20 could have multiple produced water supply manifolds 39. Evaporate exits the evaporator system 1 at steam outlets 33 and enters an evaporate manifold not shown. In a preferred embodiment there is one evaporate manifold for the solar system 20 but there could be multiple evaporate manifolds, if needed. In one embodiment, the evaporate is passed or flowed into a heat exchanger 34, which can be a plate heat exchanger or a shell and tube heat exchanger to recover the heat energy to preheat the produced water entering the evaporator 1. In another embodiment, the solar system 20 could have a condensing coil to cool the evaporate back into the liquid phase.

In one embodiment, some of the produced water that is not evaporated is called brine reject discharge water, or concentrate, or concentrated brine and exits the evaporator at outlet 35, as shown in FIG. 2. This unevaporated brine could be circulated through a heat recovery evaporator to transfer the heat energy to the produced water coming into the system 20.

The solar heat transfer fluid, which is preferably an environmentally friendly mineral oil, in a preferred embodiment enters through opening 9b as shown in FIG. 1b at the top of the outermost annulus 8. In another embodiment the thermal transfer fluid could enter the evaporator 1 at the bottom through opening 9a as shown in FIG. 1c, which is the outermost annulus. The heated fluid is circulated through the outer annulus 8 while it transfers energy via these fins to the inner evaporation column 6, which is in the innermost annulus where evaporation and separation occur. The fluid cools during the heat transfer and exits the system 1 towards the top through opening 9a. The exited fluid is pumped back through the solar panels 21 as shown in FIG. 2 to be reheated by solar energy. Additional heat transfer fluid materials include but are not limited to synthetic oils, glycol, water, steam, air, nitrogen, molten salt, and combinations thereof.

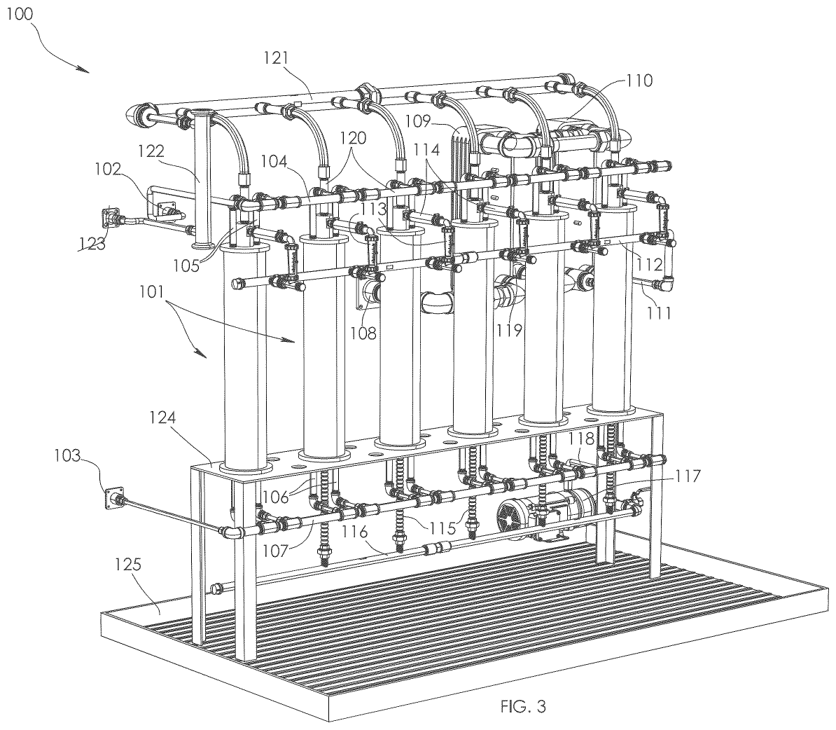

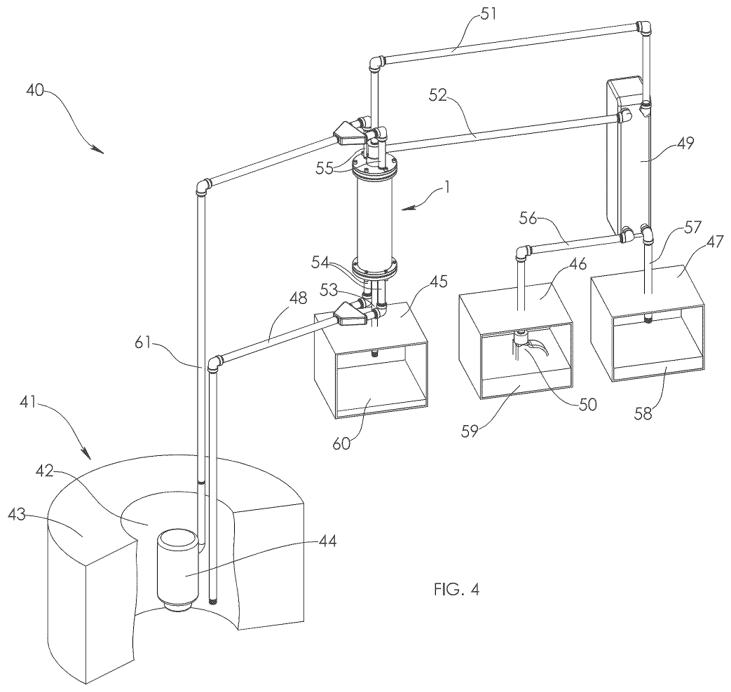

FIG. 3 shows a more detailed perspective of one embodiment of a skid system 100 used for solar powered evaporation comprising a bank of individual evaporators 101 connected in parallel. The skid system shown in FIG. 3 for solar powered evaporation could also be adapted to be used for a geothermal well fluid heated evaporation or any other alternative heat energy source including solar thermal and waste heat recovery.

The solar skid system 100 has a thermal fluid inlet 102 and an outlet 103. Heated thermal transfer fluid heated from solar panels or other alternative source enters the skid system at inlet 102 into supply fluid manifold 104. Connected to manifold 104 is a plurality of conduits 105 that connect the manifold 104 to the top of the evaporators 101. In a preferred embodiment, a plurality of conduits 105 can connect each evaporator to the manifold 104. However, in an alternative embodiment, there may be only a single conduit connecting each evaporator 101 to the manifold 104. The hot thermal transfer fluid flows out of the manifold 104 through conduit 105 into the top of the evaporators 101 into the outermost annulus 8 shown in FIG. 1a. As the transfer fluid flows past the heat exchanger 4 inside the evaporator 1, shown in FIG. 1a, it can exit the evaporator 101, as shown in FIG. 3 into conduits 106. Conduits 106 connect the evaporators 101 with a fluid outlet manifold 107.

In a preferred embodiment there is a plurality of conduits 106 connecting each evaporator 101 with the outlet manifold 107. In an alternative embodiment, only a single conduit could connect the evaporator 101 to the manifold 107. The fluid flows out of the evaporator 101 into conduits 106 into manifold 107 and out of the solar skid 100 at outlet 103.

Also shown in FIG. 3 is a contaminated fluid inlet 108. The contaminated fluids can be brackish water, saltwater, industrial wastewater, agricultural wastewater, or geothermal water. Contaminated fluid to be processed by the evaporators 101 enters the skid system 100. In a preferred embodiment the fluid entering the skid 100 through 108 passes through at least one heat exchanger pre-warmer 109 to recapture the heat energy of the heated fluid exiting evaporator 101. In a preferred embodiment the skid may have a plurality of pre-warmer heat exchangers as shown in FIG. 3 as 109 and 110. As shown in FIG. 3, a conduit 110 connects the pre-warmers 110 and 109 connected in series in a preferred embodiment to contaminated fluid supply manifold 112. As the fluid enters the manifold 112 from conduit 111 it passes through flow meters 113 shown in FIG. 3 that are adapted to regulate the rate of contaminated fluid entering the evaporators 101.

In a preferred embodiment the flow meter 113 not only regulates the flow rate but can register a flow rate value. As the fluid enters the evaporator 101 after flowing through the regulator meters 113 it passes into the innermost annulus 5, as shown in FIG. 1a. A portion of the contaminated fluid is not evaporated by the evaporator 1, 101 known as brine, or concentrated brine, exits the evaporator 101 into outlet conduit 115 as shown in FIG. 3. Outlet manifold 116 is connected to the evaporators 101 by conduit 115. The skid system 100 has a pump 117 that connects to the manifold 116 and has a conduit 118 that connects the pump 117 to pre-warmer heat exchanger 110. The brine is hot, and the heat of the almost evaporated brine fluid is exchanged to the cooler contaminated water coming into the system 100 at inlet 108. After heat is removed from the brine it exits the system 100 at outlet 119, which can also serve as an energy recapture system or heat recovery system.

Also shown in FIG. 3 is evaporate outlet conduit 120. A portion of the contaminated fluid entering the evaporators 101 is evaporated and exits through conduit 120 into evaporate manifold 121. In a preferred embodiment, the heat exiting the evaporator by the evaporator could be recaptured by a heat exchanger (not shown) or a condenser with heat recovery. Evaporate manifold 121 is connected to a heat exchanger 122 to condense the vapor back to liquid as a purified fluid. Examples of suitable heat exchangers include plate heat exchangers, coiled heat exchangers and shell and tube heat exchangers. There are many embodiments not shown of a condensing system or heat exchanger system not shown that could be used as an alternative. The condensed evaporate exits the skid system at outlet 123.

Also shown in FIG. 3 is table 124 that may support the evaporators 101, manifolds 107,116,104, and 121 as well as the pre-warmers 109,110 or any other components needed for the skid system 100. The skid system 100 also may have a secondary containment 125 that could temporarily capture any accidental spills that may occur within the system 100. Preferably, the containment zone, would have a leak detection system, connected to the control system that is described later. In this embodiment, the leak detection system will shut down the water flow if any water leaks are detected.

For the natural gas version, a burner (not shown) combusts gas. The flue gas from the gas combustion provides the heat energy source for the heat exchanger 4. In one embodiment, waste gas is utilized. The waste gas can be recovered flare gas from an industrial plant, oil well or landfill can provide the waste gas source. In one embodiment, flare gas recovered at a garbage dump or landfill site can be used to purify landfill leachate water onsite.

In another embodiment shown in FIG. 4, hot geothermal fluid is used for a surface geothermal evaporator system 40 having an evaporator system 1 as shown in FIG. 1a and FIG. 4. Downhole inside the geothermal well bore 42 of well 41, a pump 44 circulates hot geothermal well fluid through supply conduit 61 up to the evaporator 1. The hot geothermal fluid enters the evaporator through conduits 55 through openings 9b and into the outer annulus 8 of the evaporator 1 as shown in FIG. 1a. As heat is transferred from the hot geothermal fluid to the heat exchanger finned tube 4 the fluid loses temperature. The cooled fluid exits the evaporator system 1 through openings 9a and into conduits 54 and into return conduit 48 to be reinjected into the well bore 42, as shown in FIG. 3. In an alternative embodiment, the hot geothermal fluid could enter the evaporator system 1 at the bottom from supply conduit 61 through openings 9a and exits the evaporator system 1 at the top through openings 9b to return conduit 48.

The evaporation takes place inside the inner annulus 5 of the evaporator system 1 as described above and shown in FIG. 1a. In one embodiment, produced water 59 is circulated to the evaporator system 1 from a produced water supply 46 by pump 50 as shown in FIG. 4. In a preferred embodiment, the produced water is preheated by heat exchanger 49 with the hot evaporate exiting the system 1 as described above. In an alternative embodiment (not shown), the produced water supplied to the evaporator system 1 could be further preheated by a second heat exchanger using the hot brine 60 after the hot brine exits the evaporator 1. In one embodiment, the unevaporated produced water exits the evaporator system at the bottom through conduit 53 and into brine storage 45. In a preferred embodiment, the hot brine 60 could be circulated through a prewarming heat exchanger (not shown) before it flows into brine storage 45. The brine could be further processed to remove valuable materials or minerals or sent downhole into the geothermal well for disposal.

### Chemical Critical Material Removal

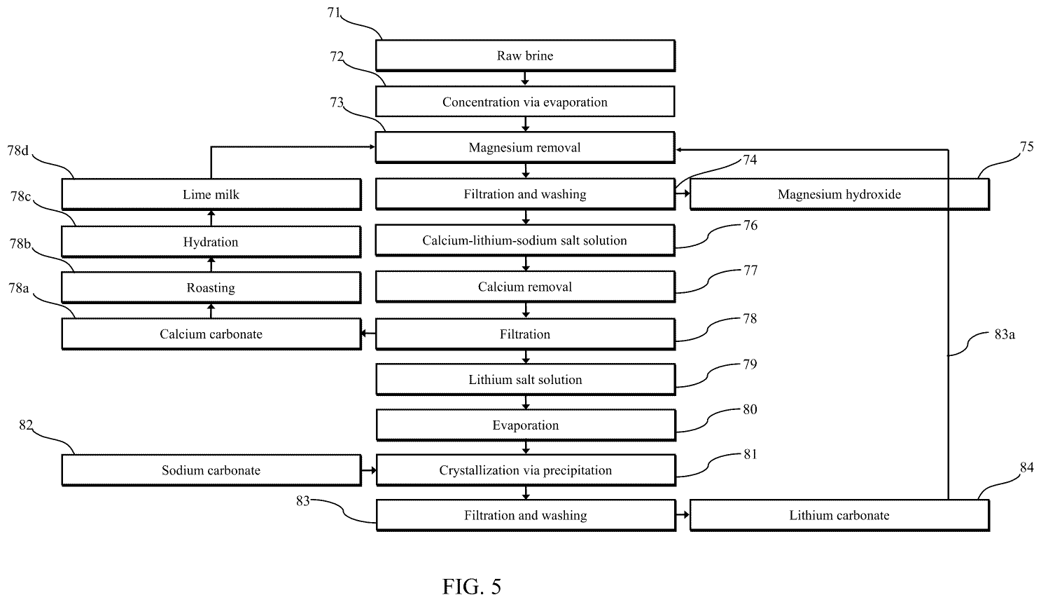

There are many methods for removing critical materials from a water stream. FIG. 5 is a diagram showing the lithium extraction process from raw brine 71 containing a critical material of interest such as, lithium. In alternative embodiments, other critical materials can be extracted in similar manners to the lithium. Persons skilled in the art with the benefit of the disclosures herein will recognize how to amend the process shown in FIG. 5 to remove any critical material of interest. As shown by FIG. 5, in one embodiment, the process is complicated with many steps, recycles, and chemical species.

The process includes first obtaining a brine 71. Second, the brine 71 is subjected to an evaporation process 72, as described above, to obtain a concentrated brine. Magnesium is then removed 73 followed by filtration and/or washing 74 to remove the magnesium as a magnesium hydroxide 75. This leaves behind a calcium-lithium-sodium salt solution 76. After the calcium-lithium-sodium salt solution 76 is created, the calcium is removed 77 followed by filtration 78 to remove the calcium in the form of calcium carbonate 78a. The calcium carbonate 78a can then be subjected roasting 78b and hydration 78c to create lime milk 78d which can then be recycled, as shown by arrow 78e for use in the magnesium removal 73. The lithium-sodium (and possibly other) salt solution 79 is then subjected to an additional or second evaporation process 80 followed by precipitation crystallization 81. In one embodiment, sodium carbonate 82 is used to precipitate the lithium followed by filtration and washing 83 to create a lithium carbonate 84 which can be sold to market.

The removed lithium carbonate can be optionally further refined by inserting it back into the lithium extraction process as shown by arrow 83a. The removed lithium carbonate can then be used in the calcium removal process 77. In one embodiment a portion of the lithium carbonate 78 can be used to facilitate the calcium removal 77. Biosorption technology has the potential to streamline the removal of lithium from brines by advancing the field of selective separation into a simple repeatable process to remove critical materials of interest such as lithium as well as other critical materials.

### Adsorption Critical Material Removal

In one embodiment, contaminated water is treated followed by critical material removal such as, lithium using biological organisms to selectively adsorb critical materials including lithium and rare earth elements. This technology has application in any industrial water process where effluent water contains critical materials and can be powered using waste heat, flared gas, or even renewable energy. Compared to physical/chemical technologies, bioaccumulation has the advantages of low cost, high efficiency, and environmental friendliness.

Biosorption can be used instead of chemical removal process or in combination with chemical removal processes if several critical materials of interest or targets are being removed. Biosorption relies on the ability of living and/or non-living biomass to rapidly adsorb and concentrate, through physicochemical pathways, metal ions from even dilute aqueous solutions. More specifically, certain micro-organisms are reported to adsorb metals to the cell wall functional groups such as carboxyl, carbonyl, sulfonyl, phosphate, hydroxyl, or amine groups. These functional groups give the micro-organisms certain ion exchange capacity, which can be leveraged to reversibly remove metal ions of value from wastewater.

Compared to traditional metal removal methods, adsorption/desorption using biological organisms has the advantages of low cost by leveraging natural biological growth as a material source, high efficiency, and environmental friendliness. Biosorption is well-researched and biosorbents are abundant due to industrial fermentation waste products. As such, biosorption may be an ideal candidate for critical material recovery in wastewater treatment. In the past, this has not been done due to the economics of handling and treating the water which is now being addressed through the use of more efficient concentration devices, processes and systems. These concentration devices include the thermal desalination devices, processes and systems that are described earlier and are shown in FIG. 1, FIG. 2, FIG. 3, FIG. 4, and the cited references.

Many biomaterials (e.g., algae, bacteria, fungi, plants, and yeasts) have been reported to biosorb critical materials such as lithium and subsequently release the lithium into solution. Non-living microbial biomass offers advantages over living microorganisms for biosorption: they do not require nutrients, are not affected by toxic heavy metals, can handle high salinity or high TDS, and can be stored for long periods. Physical and chemical pretreatment methods can improve the adsorption qualities of the biomass.

Table 1, as shown below, lists twelve biomaterials that are known to accumulate lithium. See Hydrometallurgy 150, 2014, 192. B.D. Pandey; J. Chem. Sci. Technol. 3, 2014, 74. SH Abbaas; J Rare Earths 31, 2013. N Das; Hydrometallurgy 103, 2010, 180. N Das; Water Res 41, 2007, 4017. B Volesky; Hydrometallurgy 44, 1997, 301. Veglio F; and Biosorption of Heavy Metals. Florida: CRC press; 1990, 3. Volesky B. Table 1 lists the organism's name, type of organism, the amount of lithium accumulation, whether the organism is modified and whether the organism is immobilized. Type of organism chosen will depend on additional factors including, price, ability to rapidly generate the organism, recycle the organic matter, the ability of the organism to selectively biosorp only the critical materials of interest, and combinations thereof.

If an organism adsorbs multiple materials in the brine water, it may be necessary to remove that material first either using a chemical process, described earlier, or a biological absorption process as described herein. If the material biosorps multiple materials that are valuable it may be prudent to allow a recycling facility or the end user customer to separate the materials at a later date. In a preferred embodiment, the chemical, biological and physical processes used are driven by economics to achieve the most favorable outcome, as discussed later.

TABLE 1
Lithium Accumulating Organisms

| | | Li | | |
|---|---|---|---|---|
| | | Accumulation | | |
| | | (μmol/g dry | | |
| ORGANISM | TYPE | wt) | Modified | Immobiled |
| Arthrobacter nicotianae | Bacteria¹ | 125.8 | N | Both |
| IAM12342 | | | | |
| B. megaterium IAM11661 | Bacteria¹ | 82.7 | N | N |
| B. subtilis IAM10261 | Bacteria¹ | 74.6 | N | N |
| Brevibacterium helovolum | Bacteria¹ | 98.1 | N | N |
| IAM16371 | | | | |
| S. olivaceus HUT6061 | Actinomycetes¹ | 73.9 | N | N |
| Pichia stipitis (modified) | Yeast² | 245.3 | Y | N |
| Arthrospira (Spirulina) | Cyanobacteria³ | 252 | N | N |
| platensis | | | | |
| Aspergillus versicolor | Fungi⁴ | 348 | N | N |
| Kluyveromyces marxianus | Yeast⁴ | 409 | N | N |
| Oocystis solitaria | Algae⁵ | 28800 | N | Both |
| Dry baker's yeast | Yeast⁶ | NA | Y | N |
| B. subtilis | Bacteria⁷ | NA | Y | N |

Besides lithium, there are many other critical materials that can be accumulated and removed using microbes. Our literature search has found microbes for almost every critical metal listed in the Department of Energy's (DOE's) Critical material list except magnesium. Magnesium can be removed by known chemical processes and most likely will be removed before the biological processes. In one embodiment, magnesium is removed during pretreatment processes to avoid chemical or biological process issues later in the process. Table 2 lists the type of critical material or metal that is being targeted, the microbe or organism known to accumulate that targeted metal, the quantities used, the reference documenting this information. In addition, some notes are provided that may be helpful to the operator or persons skilled in the art performing the critical material removal process.

As shown below in Table 2, disclosed are ten critical materials included in the table that were picked because these materials are typically found in wastewater and have significant market value. Persons skilled in the art can find additional critical materials and known microbes or organisms to accumulate additional critical materials of interest in the prior art literature and will know how to apply that knowledge with the benefit of the disclosures herein. Accordingly, the process steps and devices described herein have enabled this bioengineering knowledge to be utilized in the removal of critical materials from wastewater.

TABLE 2
Critical Material Accumulating Organisms

| | MICROBE/ | | | | |
|---|---|---|---|---|---|
| METAL | ORGANISM | QUANTITY | | REFERENCE | NOTES |
| Bismuth | Scopulariopsis | 13.5 | mg/g | K. Boriov, Bioaccumulation | filamentous |
| (Bi) | brevicaulis | | | and bio volatilization of | fungus |
| | 1524 | | | various elements using | |
| | | | | filamentous fungus | |
| | | | | Scopulariopsis brevicaulis. | |
| | | | | Letters in Applied | |
| | | | | Microbiology 59, 217--223, | |
| | | | | 2014 | |
| Cerium (Ce) | B. cereus | 7.05 μg/g | | S. Maruthamuthu, | |
| | | dry wt | | Bioaccumulation of cerium | |
| | | | | and neodymium by Bacillus | |
| | | | | cereus isolated from rare earth | |
| | | | | environments of Chavara and | |
| | | | | Manavalakurichi, India. Indian | |
| | | | | J Microbiol, 2011, 51: 488-495 | |
| | phosphorylated | 0.72 mmol/g | | Ojima, Y. | |
| | dry | dry wt | | www.nature.com/scientificreports, | |
| | baker's yeast | | | 2019, 9: 225, 1-9 | |
| | cells | | | | |
| Cobalt (Co) | Escherichia | 4.8 mg | | Duprey, A. “NiCo Buster”: | |
| | coli K-12 | Co/gDW | | engineering E. coli for fast and | |
| | MG1655, | | | efficient capture of cobalt and | |
| | | | | nickel. 2014, J. Biol. Eng. | |
| | | | | 8: 19. doi: 10.1186/1754-1611- | |
| | | | | 8-19 | |
| | Pseudomonas | | | Kang, S. Metal removal from | |
| | aeruginosa | | | wastewater by bacterial | |
| | | | | sorption: Kinetics and | |
| | | | | competition studies. Environ. | |
| | | | | Technol. 2005, 26, 615-624 | |
| | Zooglea spp | 25% dry | | Gunasekaran, P. Microbes in | |
| | | weight | | Heavy Metal Remediation. | |
| | | | | Ind. | |
| | | | | J. Exp Biol, 2003, 41, 935-41 | |
| Dysprosium | Penidiella sp | 910 ug/mg | | T Horiike, Applied and | An |
| (Dy) | strain T9 | dry weight | | Environmental Microbiology, | acidophilic |
| | | | | 2015, 81, 3062-8. An | fungus |
| | phosphorylated | 0.72 mmol/g | | Ojima, Y. | |
| | dry | dry wt | | www.nature.com/scientificreports, | |
| | baker's yeast | | | 2019, 9: 225, 1-9 | |
| | cells | | | | |
| Gallium | | | | In situ and ex situ | Microbial |
| (Ga) | | | | bioremediation of | bioaccumulation |
| | | | | radionuclide- | was |
| | | | | contaminated soils at nuclear | reported for |
| | | | | and norm sites A.J. Francis, | gallium. |
| | | | | Y.V. Nancharaiah, in | Disclosed |
| | | | | Environmental Remediation | in this book |
| | | | | and Restoration of | |
| | | | | Contaminated Nuclear and | |
| | | | | Norm Sites, 2015 | |
| Magnesium | | | | | Nothing |
| (Mg) | | | | | Found |
| Neodymium | B. cereus | 7.05 ug/g | | S. Maruthamuthu, | |
| (Nd) | | dry wt | | Bioaccumulation of cerium | |
| | | | | and neodymium by Bacillus | |
| | | | | cereus isolated from rare earth | |
| | | | | environments of Chavara and | |
| | | | | Manavalakurichi, India. Indian | |
| | | | | J Microbiol, 2011, 51: 488-495 | |
| | Penidiella sp | ~1 mg/mg | | T Horiike, Applied and | An |
| | strain T9 | dry weight | | Environmental Microbiology, | acidophilic |
| | | | | 2015, 81, 3062-8. | fungus |
| | phosphorylated | 0.77 mmol/g | | Ojima, Y. | |
| | dry baker's | dry wt | | www.nature.com/scientificreports, | |
| | yeast cells | | | 2019, 9: 225, 1-9 | |
| Praseodymium | Penidiella sp | ~1 mg/mg | | T Horiike, Applied and | An |
| (Pr) | strain T9 | dry weight | | Environmental Microbiology, | acidophilic |
| | | | | 2015, 81, 3062-8. | fungus |
| | Sargassum sp | 0.71 | mmol/g | RC Oliveira, Process Biochemistry | Phaeophyta |
| | | | | 2011, 46, 736-744. | group |
| | | | | Samarium(III) and | (brown |
| | | | | praseodymium(III) biosorption on | seaweed) |
| | | | | Sargassum sp.: Batch study | |
| Samarium | Sargassum sp | 0.65 | mmol/g | RC Oliveira, Process Biochemistry | Phaeophyta |
| (Sm) | | | | 2011, 46, 736-744. | group |
| | | | | Samarium(III) and | (brown |
| | | | | praseodymium(III) biosorption on | seaweed) |
| | | | | Sargassum sp.: Batch study | |
| | Bacillus | 0.25 | mg/g | EC Giese, Applied Water Science, | B subtilis |
| | subtilis | | | 2019, 9: 182. Biosorption of | either acid |
| | | | | lanthanum and samarium by | or base |
| | | | | chemically modified free | pretreated |
| | | | | Bacillus subtilis cells | |
| | B. | 316 umol/g | | T Tsuruta. Journal of Rare Earths, | |
| | lichemiformis | dry wtT | | 2007, 25, 526-532 | |
| Tungsten (W) | Escherichia | “great W- | | Coimbra C. Systematic and | |
| | coli cells | bioaccumulators” | | Applied Microbiology, 2019, 42, | |
| | expressing the | | | 126001. Efficient | |
| | native S. | | | bioaccumulation of tungsten by | |
| | dubius | | | Escherichia | |
| | TupABC | | | coli cells expressing the | |
| | system | | | Sulfitobacter dubius TupBCA | |
| | | | | system | |

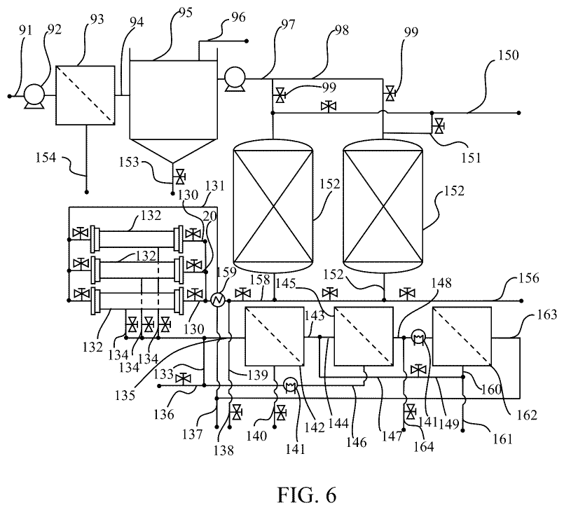

In a preferred embodiment, contaminated water is treated via selective adsorption using biological organisms and captured critical materials such as lithium are recovered using chemical precipitation. As shown in FIG. 6, contaminated water 91 is pressurized with pump 92 and fed to a settler 93 to remove suspended solids 154. The clarified water 94 is additionally treated in process 95, which uses sparged air 153 to remove volatile organic compounds and suspended hydrocarbons 96. The effluent 98 of process 95 is split in streams 98 and 99 and fed to adsorption columns 152, which are filled with biological material chosen, as described above. Control valves 99 regulate the process conditions and regeneration of the sorbent.

Waste produced during regeneration or backwashing can be extracted from stream 150 and stream 151. Effluent 157 from columns 152 is fed to pipe 158 which encounters a heat exchanger 159 to be pre-heated before entering evaporators 132. Pure water vapor 131 from evaporators is fed back through the heat exchanger 159 to remove waste heat and condense for later use in stream 137. Concentrated brine 134 is further treated using filtration 142 to remove magnesium hydroxide 140 after calcium hydroxide from stream 146 is recycled in stream 133 to precipitate the magnesium hydroxide 140. Effluent containing calcium, sodium, and lithium salts encounters lithium carbonate recycled from stream 160 and precipitates to form a calcium carbonate slurry 144 which is filtered in step 145 to remove calcium carbonate 146. Calcium carbonate 146 can be roasted and hydrated 141 to form calcium hydroxide 133 which is recycled to the first stage.

A portion of this stream is purged 136 to prevent the accumulation of impurities. The resulting lithium and sodium brine 148 is contacted with sodium carbonate 164 and a heater (not shown) before entering the third filtration step 162 wherein concentrated wastewater 163 is separated from lithium carbonate 160, from which a portion 161 is removed as product and the balance recycled to precipitate the calcium. Wastewater 153 is mixed with wastewater 131 after flowing through heat exchanger 159 to be disposed in stream 137.

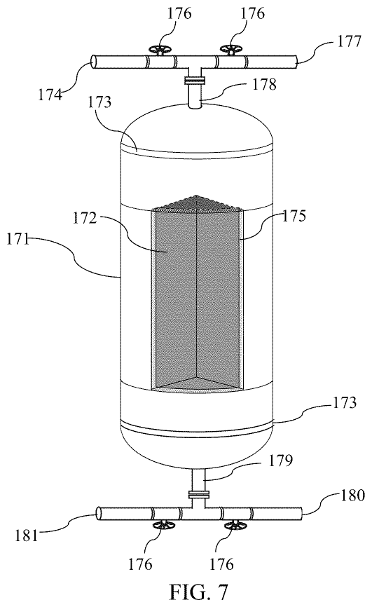

In many embodiments, a simple adsorption column filled with biological materials will be utilized. FIG. 7 provides a more detailed description of this unit operation. As shown in FIG. 7, a device, typically a stainless-steel column 171 will be filled with relevant biomass 172 which is retained by panel 173. A feed stream including critical materials enters in 174 and process is controlled using valves 176. In some embodiments, the feed may be split between multiple columns using extension 177. Extension 177 can also serve as a waste port. Wastewater 178 enters the top of the column and flows under the force of gravity within biosorbent 172 contained by column walls 175. Treated wastewater exits via stream 179 for disposal between streams 180 and 181 controlled using valves 186.

In an alternate embodiment wherein, a critical material is directly captured to the biosorbent, fewer steps would be necessary. One embodiment is to put the biosorbent on an online filter by adhering the biosorbent to a structure that allows the water to pass through channels small enough to enable the biosorbent to remove the lithium or other targeted metal. The filter with the biosorbent can then be removed for metal recovery and a new filter with fresh biosorbent inserted into the online process. The filter with the metal adsorbed can then have the biomass removed for further treatment. The critical materials can be removed by pH swing, centrifugation, or other processes.

### Biological Method Steps

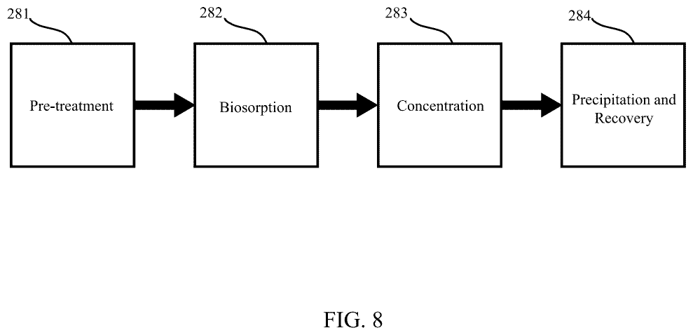

FIG. 8 shows a simplified method embodiment. As shown in FIG. 8, the water is first sent to a pretreatment system 281, to remove any metals that may adversely affect the process. Pretreatment systems were described previously and by the literature that was incorporated by reference, as described above. Second, microbes or organic material is used to biosorp 282 the critical material of interest. Third, the feed stream is dewatered 283 to increase the concentration of the critical material undergoing absorption. In some embodiments, step 2 shown as 282 and step 4 shown as 283 can be switched in order. Fourth, the critical material of interest undergoes a precipitation and recovery step 284. This may entail pH swing to cause the critical material to precipitate out of solution, followed by removal such as, filtering. The pH swing is caused by the addition of chemical, such as, lime or calcium hydroxide which causes the pH level of the water to increase allowing the critical material of interest to precipitate out of solution in the water or biological material holding the critical material. Alternatively, an acid can be used to decrease the pH. See FIG. 2 of Takehiko Tsuruta, Removal and recovery of lithium using various microorganisms, Journal of Bioscience and Bioengineering, Volume 100, Issue 5, 2005, Pages 562-566, ISSN 1389-1723, https://doi.org/10.1263/jbb.100.562.

In one embodiment, the pH is increased, or alternatively decreased, by at least two, preferably at least 4, and most preferably at least 5. In one embodiment, the sorbent is regenerated with an acid to reduce the ph. In another embodiment, the sorbent is regenerated with a base to increase the pH. The precipitated critical material or materials can be removed by filtration. Alternatively, the critical materials can be removed by solvents or other chemical processes or other physical means including centrifuge devices.

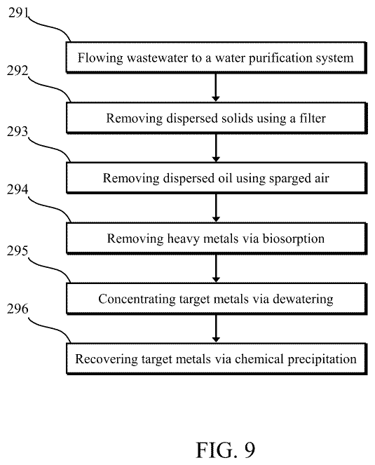

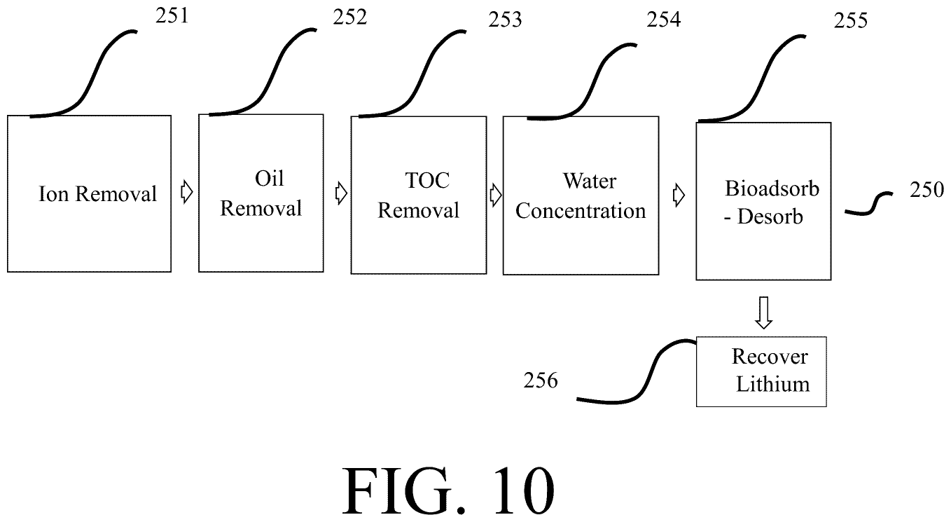

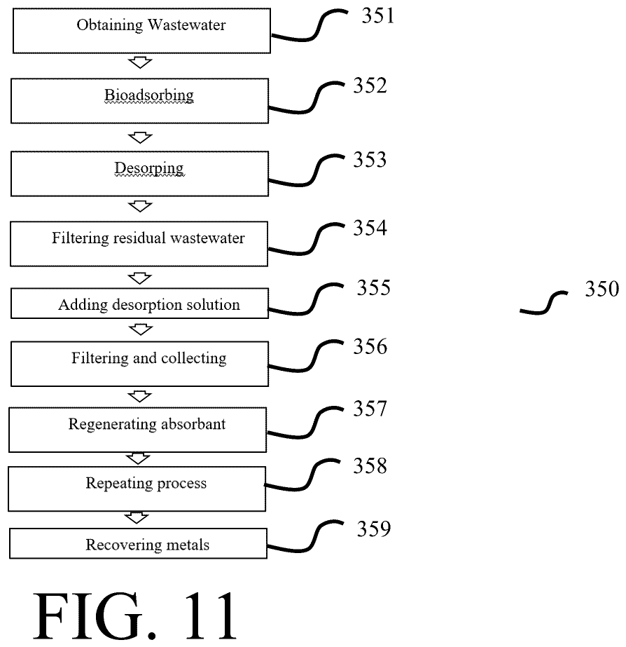

FIG. 9 illustrates a method embodiment for removing critical materials or target materials from waste water containing oils or hydrocarbons including produced water found at oil and gas sites. As shown in FIG. 9, first, wastewater is flowed into a water purification system 291. Second, dispersed solids are removed using a filter 292. Third, dispersed oil is removed using sparged air 293. Alternatively, other oil removal process include MMBR processes, oxidation and electrocoagulation, combinations thereof and other techniques known to persons skilled in the art. Fourth, heavy metals or critical materials are removed by biosorption 294, as described previously. Fifth, the target metals are concentrated via dewatering 295. Sixth, target metals are recovered via chemical precipitation 296.

To allow field removal of the critical materials of interest, a field device can be created and utilized to grow and/or store the microbes and remove the critical materials in an inline system. Preferably, this system will be incorporated into previously existing water treatment and handling systems to reduce the costs in transporting and storing the water.

In one oil and gas embodiment 250, there are 6 main steps, as shown in FIG. 10. This embodiment enables the ability to remove critical materials of interest directly at an oil and gas wellsite or preexisting water gathering stations. First, any or at least one competing ion is removed 251 from the water. These competing ions include magnesium, which is often removed using pretreatment steps, as discussed earlier. Second, oil is removed 252 if the amount of oil, or other containments, in the wastewater it too high. A common oil removal technique is dissolved air flotation (DAF). In a DAF system, flotation oil and other contaminants are achieved from air bubbling in the water flowed by skimming of the floating materials, which is typically oil. The oil can then be disposed of or recycled. Third, total organic carbon is reduced 253 or removed. One embodiment is to use a moving bed biofilm reactor (MBBR) system. MBBR systems can be operated in an anaerobic environment or aerobic environment depending on the type of organic material that is needed to be removed. Fourth, the water is concentrated 254. One embodiment is to use a thermal distillation system as a concentration device to concentrate the water. Fifth, a bioadsorption system is used followed by desorption system process 255, as discussed previously. Finally, the metal ions of interest are recovered 256 or removed using removal techniques described previously.

One critical material removal process embodiment 350, requires several steps, as shown in FIG. 11. First, wastewater is obtained 351 containing at least one critical material such as, lithium or REE. First the critical material is bioadsorbed 352 using at least one type of microbe. Second, the critical material is desorbed 353 to remove at least one critical material of interest into a solution. Third, the residual wastewater from the solution containing at least one desorbed critical material of interest is filtered 354. Fourth, a desorption solution is added 355, usually to the tank. Fifth, at least one critical material is filtered and collected. 356 Sixth, an adsorbent is regenerated 357 from the water, typically in settling tanks. Seventh, steps are repeated 358 as necessary. In particular, step three through sixth are repeated either as a single step or a combination of steps, as needed. Eighth, the critical material of interest is recovered 359 and recycled or sold to customers.

### Control System

In one embodiment, a control system is provided with the apparatus and/or method to create a system for obtaining favorable operation and performance of the apparatus and method. Factors to be considered for favorable operation of the apparatus and system include, but are not limited to, energy costs, energy production and water needs, amount of brine discharge, concentration and physical properties of brine discharge, properties of sea water, design of the equipment, operational conditions of the equipment, pressure, density, temperature, other differences between the discharge brine and sea water and combinations thereof.

In one embodiment, the controls can be standard manual or even automated controls. However, the discharge system can achieve even greater efficiencies and improved performance by using more advanced control systems, which may include a signal capture and data acquisition (“SCADA”) system. SCADA is also an acronym for supervisory control and data acquisition. Typically, SCADA is a computer system for gathering and analyzing real time data. SCADA systems are used to monitor and control a plant or equipment in industries such as telecommunications, water and waste control, energy, oil and gas refining and transportation. A SCADA system gathers information, through equipment, such as sensors or gauges, and transfers the information back to a central site. The central site can collect the information necessary for efficient analysis and control of the plant, which includes, but is not limited to, determining if operational changes are advantageous or necessary, and displaying the information in a logical and organized fashion. SCADA systems can be relatively simple, such as one that monitors environmental conditions of a small building, or complex, such as a system that monitors all the activity in a nuclear power plant or the activity of a municipal water system. In addition, recent improvements in computer power and software configurations enable entire systems to be operated in real time with, or without, human interaction. The real time capabilities allow the control system to make decisions based on multiple factors and operate the water purification system favorably with little or no operator interaction.

Persons skilled in the art, with the benefit of the disclosures herein, would recognize similar monitoring and/or control systems that can be operatively connected therewith the disclosed apparatus, and which may thus be used in conjunction with the overall operation of the system. The SCADA control system can utilize a computer with a display panel, keyboard, and wireless router or may include any manner of industrial control systems or other computer control systems that monitor and control operation of the system. In one embodiment, the SCADA system may be configured to provide monitoring and autonomous operation of the system.

The SCADA controlled system may be interfaced from any location on the apparatus, such as from an interface terminal. The interface terminal can include cellular or satellite communication equipment, a wired or wireless router, servers or traditional wired connections, or any combinations thereof. In the embodiment shown in schematic FIG. 18, sensor(s) and/or corresponding controls could be connected to the interface terminal (not shown).

In an embodiment, the SCADA system including a portion, or all of the interface equipment and controls can be on an operations section of the apparatus. Additionally, alternatively, or as a backup, the SCADA controlled system may be interfaced remotely, such as via an internet connection that is external to the apparatus. A usable internet interface may include a viewer or other comparable display device, whereby the viewer may display real-time system performance data. In other embodiments, the SCADA system may be able to transfer data to spreadsheet software, such as, Microsoft Excel. The data may be related to temperature, salinity, heat or cooling needs, excess energy or cogenerations from industrial processes, pressure, flow rate, discharge rates, and/or other similar operational characteristics of the system.

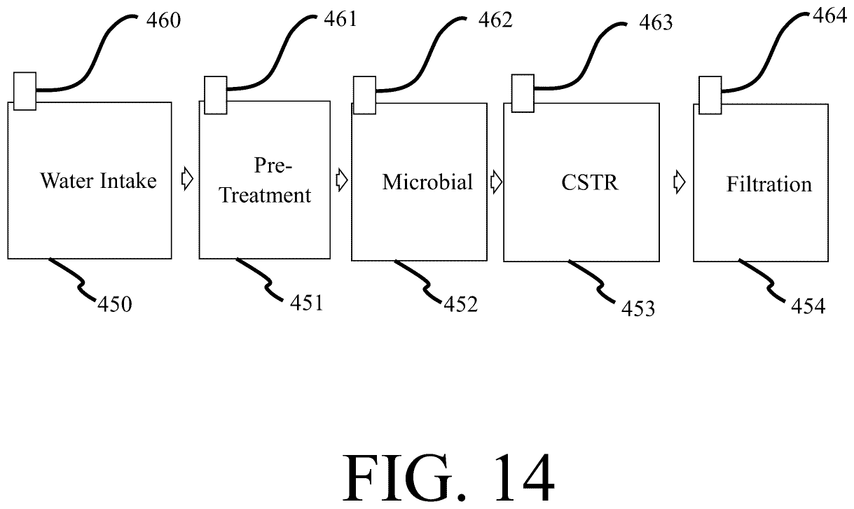

The operations of the system may utilize a number of indicators or sensors, such as optical cameras, infrared cameras, ultrasonic sensors, lasers, density, electrical resistivity, sight glasses, liquid floats, temperature gauges or thermocouples, pressure transducers, etc. In addition, the system may include various meters, recorders, and other monitoring devices, as would be apparent to one of ordinary skill in the art. Sensors (460, 461, 462, 463, and 464) are shown in FIG. 14. These sensors, shown in FIG. 14, are for the following: initial water intake 460 on the inlet device 450, the location 461 after the water has been treated by the pretreatment system 451, the location 142 after the water has been bioabsorped by the microbes, typically in a CSTR device 221, the location 463 after the water has been treated by filtration devices 452, 464 the remaining wastewater, and 465 at the water recycling stream 453. Additional sensors can be deployed as needed. If needed, the discharge system can have its own SCADA system, as disclosed in U.S. Patent Application No. 2017/0113194 that can be operated alone or in combination with this SCADA system. One or more additional sensor(s) can be placed inside the equipment, pipes, containers and inlets to determine quantity and/or quality of the water through the process (not shown) and other sections throughout the discharge pipes and alternative pipe sections would provide additional monitoring and control abilities.

These devices may be utilized to measure and record data, such as the quantity and/or properties of the discharge brine including salinity, amount of fluid flow, and type of fluid flow including turbidity and salinity directly before and after discharge. Additional sensor(s) could be placed on other equipment to determine the operational conditions of the filters and water processing equipment, how efficiently the water is being filtered and desalinated and the mixing of the discharge and how much energy is produced from the turbines on the discharge device.

The SCADA control system may provide an operator or control system with real-time information regarding the performance of the apparatus. It should be understood that any components, sensors, etc. of the SCADA system may be interconnected with any other components or sub-components of the apparatus. As such, the SCADA system can enable on-site and/or remote control of the apparatus, and in an embodiment, the system can be configured to operate without human intervention, such as through automatic actuation of the system components responsive to certain measurements and/or conditions and/or use of passive emergency systems. In another embodiment, the system can operate in real-time wherein a plurality of factors or all relevant factors are instantaneously or nearly instantaneously determined and used to calculate the most favorable operations. This real-time operation allows all components to be operated in a coordinated manner based on information received and responded to in real time including instantaneously, or nearly instantaneously.

The system may be configured with sensors or devices to measure “HI” and/or “LOW” temperatures, density, oxygen demand or other gas demand, nutrient demands, salinity pressure, turbidity sensors, or flow rates. The use of such information may be useful as an indication of whether the fluid flow rate should to be increased or decreased and operational conditions. The system may also be coupled with heat, pressure, and liquid level safety shutdown devices, which may be accessible from remote locations, such as the industrial water, energy or external heat source (not shown) on the plant to achieve further efficiency. For example, U.S. patent application Ser. No. 14/724,803 discloses a device and system for using excess industrial heat energy to purify water. U.S. patent application Ser. No. 14/724,803 is hereby incorporated by reference. Such a device can be used to further purify water, maximize heating and cooling requirements while improving the overall efficiency of the plant.

The SCADA system may include a number of subsystems, including manual or electronic interfaces, such as a human-machine interface (HMI). The HMI may be used to provide process data to an operator, and as such, the operator may be able to interact with, monitor, and control the apparatus. In addition, the SCADA system may include a master or supervisory computer system such as, a server or networked computer system, configured to gather and acquire system data, and to send and receive control instructions, independent of human interaction such as real time operations, as described below. A communication device or digital port or remote terminal (“RT”) may also be operably connected with various sensors. In an embodiment, the RT may be used to convert sensor data to digital data, and then transmit the digital data to the computer system. As such, there may be a communication connection between the supervisory systems to the RT's. Programmable logic controllers (“PLC”) may also be used to create a favorable control system. The RT and PLC would most likely, but would not necessarily, be located in the interface terminal data acquisition of the system, which may be initiated at the RT and/or PLC level, and may include, for example, gauges or meter readings such as, temperature, pressure, density, equipment status reports, etc., which may be communicated to the SCADA, as requested or required. The requested and/or acquired data may then be compiled and formatted in such a way that an operator using the HMI may be able to make command decisions to effectively run the apparatus and/or method at great efficiency and optimization. This compilation and formatting of data can be used to enable real time operations, as discussed below.

In an embodiment, all operations of the system may be monitored via control system or in a control room within the operations section. In an embodiment, the operations section may be mounted on the discharge pipes, tanks or other structures. Alternatively, or additionally, the system can be operable remotely and/or automatically.

### EXAMPLE

The hypothetical examples provided below, with a technoeconomic analysis, will help the reader understand the technology and the economic benefits of some embodiments of the invention. Following the process embodiment depicted in FIG. 6, a preliminary analysis suggests significant sales revenues using past lithium carbonate spot prices. By calculating the mass of lithium in a barrel of produced water feed and converting the mass to a dollar revenue, it is possible to predict the amount of lithium in a barrel of produced water. It is worth noting that, recent spot prices of lithium have significantly increased over the last few years due to rising demand.

TABLE 3
Greater impacts of lithium (Li) recovery
from produced water (PW).

| | | 75 ppm^{Δ} | | |
|---|---|---|---|---|
| | Production | Annual | U.S. market | Fraction of water |
| | rate^{†} | revenue* | share in 2021 | treatment costs |
| Scale | (bbl/year) | ($) | (%) | (%) |
| Single | 3.65E+04 | $21,170.00 | 0.025% | 580% |
| well-site | | | | |

*Assuming product Li₂CO₃ has a market price of~$8,000 per metric ton, and Li concentration of 75 ppm
^{Δ}Recovery assumed at 100% for ease of comparison.

$$50 \times {10}^{- 6} \times \frac{42 \times ( 1.15 \times 3.78 )}{bbl} \times \frac{74}{14} \times \$8000 = 0.58 \frac{\$}{bbl} \qquad EQUATION 1$$

As shown in Table 3, the theoretical annual revenue of a single well site, assuming a lithium concentration of seventy-five parts per million at complete recovery amounts to over twenty thousand USD, based on revenue per barrel of about fifty-eight cents, as shown in EQUATION 1. The numbers, shown in EQUATION 1 demonstrates that lithium recovery is economic in a significant percentage of U.S. oil and gas wells. Accordingly, recovery of lithium at oil and gas well could significantly help address domestic lithium demands

Revenues could also increase if the biosorber or bio-absorption technology were licensed to generate royalties or sold outright. Additional technoeconomic analysis can be performed to ascertain the significance of feedstock costs such as chemicals, adsorbent material, and process equipment, in addition to technical feasibility at scale to further optimize the equipment and processes. However, among the largest costs involved in mining and recycling are concentrating aqueous solutions by dewatering. In one embodiment, contracts to purify the produced water into freshwater quality using pre-treatment and thermal distillation process to avoid disposal costs can cover the entire costs to transport, pretreat, and store the water. This significantly improves the economic case for this technology.

This process creates concentrated metals as a by-product. Energy can be supplied by flared gas and thus, can be paid for by the customer. For example, the X-VAP™ desalination process takes two waste streams (flared gas and produced water) and generates a valuable product (freshwater), enabling a circular economy.

TABLE 4
Greater impacts of lithium (Li) recovery
from produced water (PW), cont.

| | | 75 ppm^{Δ} | |
|---|---|---|---|
| | Production | | U.S. market |
| | rate^{†} | Annual revenue* | share in 2021 |
| Scale | (bbl/year) | ($) | (%) |
| 100 well-sites | 3.65E+06 | $2,117,000.00 | 2.51% |

*Assuming product Li₂CO₃ has a market price of~$8,000 per metric ton, and Li concentration of 75 ppm
^{Δ}Recovery assumed at 100% for ease of comparison.

A further techno-economic evaluation, shown in Table 4 above, focused on the upper bound of lithium resource available. By investigating all domestic lithium resources in produced water, at just 100 well sites, it was found that about two and a half percent of US lithium demand can be met at a value of over three million USD at past spot prices, which have increased nearly ten times since 2020. At current and future lithium carbonate prices, potential revenues could be in the tens of millions of USD with the US consuming two thousand tons of lithium, or about ten thousand tons of lithium carbonate equivalent, annually, according to the latest U.S. Geological Survey (USGS) mineral commodity summaries.

In the past, experiments for microbial metal removal have ranged from minutes to 1 week. The most effective methods are typically completed in 24 hours or less. For this reason, it is anticipated, subject to field trial optimization, that most adsorption reactions in the process, should be completed in a 24-hour time frame.

Given the large residence time (up to 24 hours for 80% or more metal removal) required for the biosorption and bioaccumulation to occur, a series of 2 or more large (60,000 cubic foot capacity) continuous-stirred tank reactors (CSTRs) followed by hollow fiber filters at the end, enabling removal of all microbes. See FIG. 2 of Diep P, Mahadevan R, Yakunin AF. Heavy Metal Removal by Bioaccumulation Using Genetically Engineered Microorganisms. Front Bioeng Biotechnol. 2018 Oct. 29;6:157. doi: 10.3389/fbioe.2018.00157. PMID: 30420950; PMCID: PMC6215804. These tank reactors would allow the full capacity of our water treatment plants to pass through the biological metal removal process. Using a conservative estimate of 40% recovery, these CSTRs tank reactors could produce an estimated 39 tons/year of critical materials including REEs representing $2.3 million dollars of critical materials.

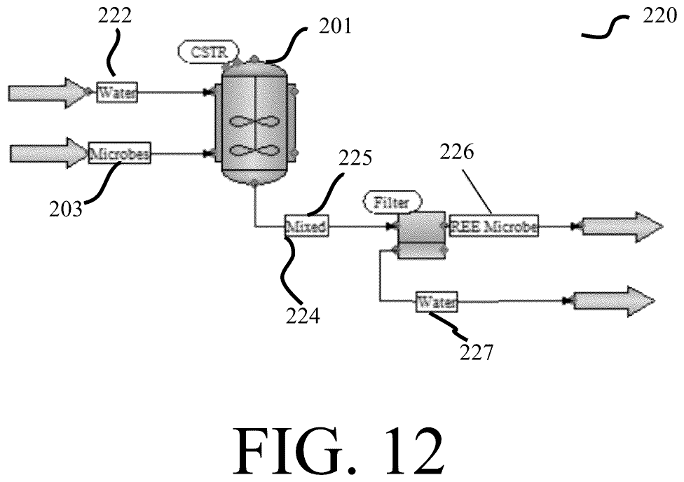

In one embodiment, as shown in FIG. 12, a CSTR system, using a CSTR device 221, as discussed earlier, is followed by a filtering step. A CSTR device 221 receives a water stream 222 with at least one critical material and microbes stream 223. In an embodiment, the CSTR device 221 acts as a bioreactor allowing the microbes 223 to adsorb the contaminants or at least one critical material in the water 222. In one embodiment the microbes 223 are alive if the microbes 223 can thrive or sufficiently survive in the water stream 222 environment. In another embodiment, non-living microbes 223 are inserted into the CSTR device 221 if the microbes 223 cannot survive in the water stream 222 environment. If only one critical material is targeted, only one type of microbe would most likely be used in the CSTR 223. If multiple critical materials are being targeted, multiple types of microbes 223 are inserted in the CSTR device 221, provided the microbes 223 selectively adsorb only the critical materials of interest or the critical materials of interest can be separated at a later step.

Some recycling centers or end users of the critical materials are willing to separate the critical material of interest at a later process. Some customers will want relatively pure levels of critical materials with only minimal levels of contaminants. Accordingly, the market will preferably determine the purity of the critical materials created at the field. The mixed stream 224 of water 222 and microbes 223 is sent to a filter 225. The filter 225 than removes the microbes from the water creating two new streams. The processed or filtered microbe stream 226 are then sent to further processing to remove the critical materials of interest and can also be recycled by allowing the protein material to be used as food to grow additional microbes. The processed or filtered water stream 227 can then be sent for further treatment or to be disposed or recycled.

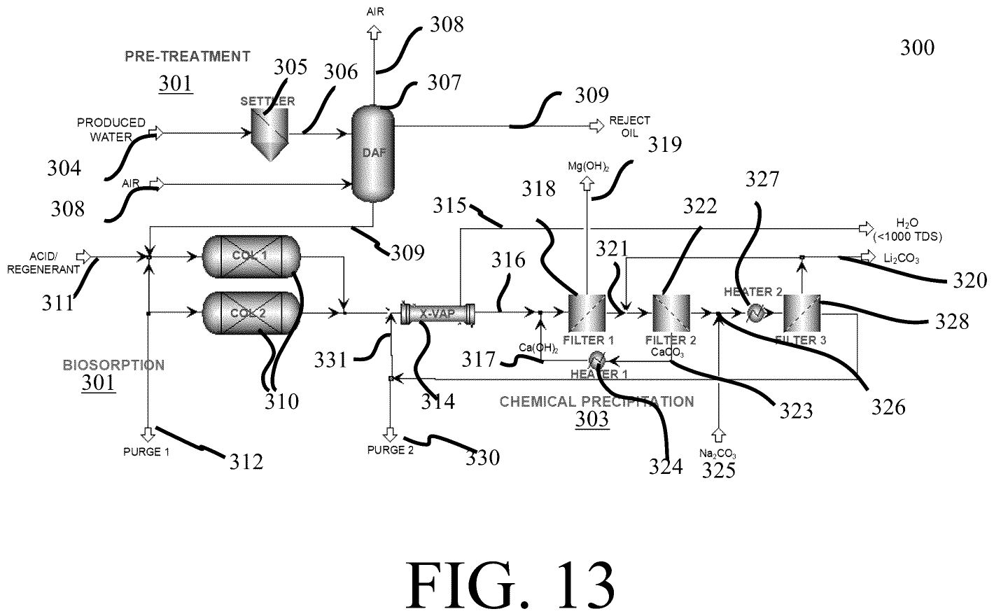

FIG. 13 is a process flow diagram 300 of an embodiment of removing critical materials for oil and as produced water. However, this process can be used on most industrial wastewater streams. This process has three main component steps. First, is a pretreatment process or step 301 that removes contaminants that may cause problems during the later process steps. Second, is a biosorption process or step 302 followed by chemical precipitation process or step 303.

The pretreatment step accepts a wastewater stream such as, oil and gas produced water 304 that is sent to a settler device 305 or solids separator device, which typically removes most solids or significantly reduces the amount of total suspended solids (TSS). Alternatively, a filter can be used to remove the solids or reduce TSS. Next, the produced water with solids removed, labeled stream 306, is sent to a DAF 307. Air 308 is bubbled or splurged through the DAF 307 to cause flotation of oil and other contaminants, such as soaps or greases. The floated oil and/or other containments is skimmed or removed for recycling or disposal as reject oil. Excess air is removed from the DAF, as stream 308.

Next, the processed water from the DAF, as stream 309, is sent to one or more collection vessels or collection tanks 310 for the biosorption process. Acid and/or regenerants are added, as needed, as stream 311 to the biosorption process 302. Excess water can be purged, as stream 312 from the collection tanks or pure streams of water containing a critical material of interest can be removed or purged. The water containing bioabsorbed critical materials can then be sent, as stream 312 to the concentration device 314. In one embodiment, the concentration device 312 is a thermal distillation system. The thermal distillation system creates a fresh water or pure water stream 315 with a TDS of less than 1,000 TDS. The heavy brine or reject brine stream 316 from the concentration process is then sent to the chemical precipitation process. Next, lithium carbonate is added to the filtered stream 303.

In the chemical precipitation process 303, a series of chemical compound addition and heat process steps are used, as needed. In one embodiment, calcium hydroxide 317 is added and then sent to first filter 318 to remove magnesium in the form of magnesium oxide 319. Lithium carbonate 320 is then added to the first filtered stream 321 before being sent to a second filter 323. The second filter 322 then removes calcium carbonate 323. The calcium carbonate 323 can be heated, in the first heater 324, to form calcium hydroxide 317 which can then be used prior to the first filtering step using first filter 318. After the second filtering step, using second filter 322, sodium carbonate 325 and can then be added to the second filtered stream 326 and then heated using the second heater 327 followed by filtering form the third filter 328. The third filtering step removes lithium carbonate 329. The remaining water can then be purged, as stream 330, or sent to additional critical material removal steps by sending it into the concentration device 314 as stream 331.

We arrived at a 40% estimated recovery by a literature review. See Water Science & Technology, 81, 499, 2020. G Yücel. One reference gives the biosorption recovery rates for various rare earth elements (REE), ranging between ˜30-65% adsorption using phosphorylated yeast. These experiments were done in 10 minutes at close to ambient temperature. One reference demonstrated the biosorption of REEs similar to those previously reported. See Environmental Science & Pollution Research, 26, 19335, 2019. N El-Naggar. One example showed 100% adsorption of lanthanum over a 1-hour time span. Each REE to be removed may require an additional CSTR if the optimal temperature and pH differ significantly for each microbe used. See Jared Lazerson, MGX Minerals Monday, Apr. 3, 2017. Table 2 in this reference indicates that a relatively small range of temperatures and acidity are required for many metal-adsorbing microbes. We anticipate, subject to further field trial optimization, that 3 or fewer CSTRs would be required for our process.

Cell recovery could be performed by alternating the output stream between multiple filter apparatuses on a daily basis. Filters, to be replaced daily, would contain less than 500 pounds of microbes to be purified. Ideal purification steps need to be optimized at the field and are dependent on the microbes used. Preference will be given to filtration techniques that allow for recovery of the microbes. Purification can often be performed by increasing the pH of the cell solution, allowing the REEs to desorb from the microbes.

In another hypothetical example embodiment, the biosorption reactions lacks a chemical reaction or phase change. The 40% adsorption would take the form as shown in equation 2 below.

$$1 m mol {REE}_{( aq )} + 1 g DCW {microbe}_{( aq )} \to \text{.6} mmol {REE}_{( aq )} + \sim 1.04 g DCW microbe - {REE}_{( aq )} \qquad EQUATION 2$$

For Equation 2 above, we assume a 10:1 mass ratio of microbes:

REE, using the literature as a baseline. (See Table 3 of Schaefer, Keith, Lithium Prices To Stay High To 2024-UBS, Jun. 19, 2017, https://oilandgas-investments.com/2017/top-stories/lithium-prices-to-stay-high-to-2024-ubs/ and 19 Table 3., 20 Table 1.)
For the setup above, as an example, a material balance would take the following form as shown in Table 5, below.

TABLE 5
Units in tons/year

| Component | Input Water | Input Microbes | Output Water | Output Microbes |
|---|---|---|---|---|
| Water | 64,000 | 0 | 64,000 | 0 |
| Microbes | 0 | 82 | 0 | 0 |
| Yttrium, Microbe-Yttrium complex | 1.0534 | 0 | 0.63 | 10.97 |
| Lanthanum, Microbe-Lanthanum complex | 1.2529 | 0 | 0.75 | 13.04 |
| Cerium, Microbe-Cerium complex | 2.9439 | 0 | 1.77 | 30.64 |
| Praseodymium, Microbe-Praseodymium complex | 0.3238 | 0 | 0.19 | 3.37 |
| Neodymium, Microbe-Neodymium complex | 1.3527 | 0 | 0.81 | 14.08 |
| Samarium, Microbe-Samarium complex | 0.2811 | 0 | 0.17 | 2.93 |
| Europium, Microbe-Europium complex | 0.0554 | 0 | 0.03 | 0.58 |
| Gadolinium, Microbe-Gadolinium complex | 0.2722 | 0 | 0.16 | 2.83 |
| Terbium, Microbe-Terbium complex | 0.0426 | 0 | 0.03 | 0.44 |
| Dysprosium, Microbe-Dysprosium complex | 0.2412 | 0 | 0.14 | 2.51 |
| Holmium, Microbe-Holmium complex | 0.0482 | 0 | 0.03 | 0.50 |
| Erbium, Microbe-Erbium complex | 0.1441 | 0 | 0.09 | 1.50 |
| Thulium, Microbe-Thulium complex | 0.0207 | 0 | 0.01 | 0.22 |
| Ytterbium, Microbe-Ytterbium complex | 0.1392 | 0 | 0.08 | 1.45 |
| Lutetium, Microbe-Lutetium complex | 0.0210 | 0 | 0.01 | 0.22 |
| Total | 64,008 | 82 | 64,005 | 85 |

The energy balance, in this case, simply considers the input of energy caused by stirring using pumps and the consumption loss of heat energy to the environment, which are minimal. In this embodiment, there are no chemical reactions generating or removing heat from the system and there is no material accumulation. Accordingly, this process will occur near ambient temperatures, with both inlets and outlets also near ambient temperature. Therefore, the only energy is the input required to run pumps and heat the water to ambient temperature-consumption. Power required for a 2-horsepower pump=1.5 kW. At 8 cents per kWh=$.08/kWh*1.5 kW*8760 h/year=˜$1,000/year per pump.

Heating water to an ambient temperature, if needed (42 k gallons/day) is ˜4.5 kW or ˜$3,000 per year (if using electric, significantly less if using gas combustion) for each degree F. above ambient temperature. Accordingly, we have the resulting nominal energy balance of: 1.5 kW+45 kW (assuming 10 F ambient temperature increase)=$31,000 per year.

Since the pretreatment energy costs including storage, transportation, processing, analysis, and concentration of water are covered by the oil and gas producers to reduce costs of their water management, this input of energy estimate is feasible. As discussed above, this collaborative effort of sharing the costs and energy requirements as part of water management costs is what will make this proposed process economically feasible. Oil and gas producers can cover the pretreatment and brine concentration costs, as these are typically less than the cost of offsite disposal which can range for 60 cents to over $4.00 per barrel depending on location.

Accordingly, in one embodiment, the competitive advantage for this process combined with existing oil and gas produced water treatment systems provides significant synergistic benefits. The ability to profitably purify oil and gas produced water means the additional removal and recovery of lithium is the only added cost. Using the technology processed herein, the cost to process and concentrate the water can be between $0.50 and $4.00. The cost to transport the water can be between $0.10 and $2 per barrel. Therefore, by performing the metal recovery onsite with water being processed, we eliminate the two highest costs of removing metals from wastewater, the cost of water transportation and processing. The additional costs to treat the water with microbes and filtration should be between $0.01 and $0.10 per barrel. The only additional energy costs are the costs to run the pumps, sensors, controls, and heaters, is needed. Additional costs include the CSTR and filtration equipment, microbes, nutrients, and testing equipment. Accordingly, the benefits of combining the microbial removal proves, with exiting oil and gas water treatment systems and water pretreatment and purification systems synergistically improves the economics of this technology.

### Membrane Removal

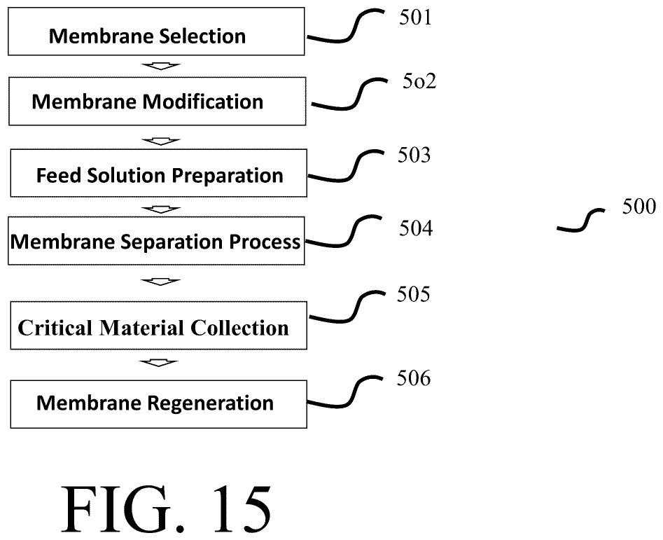

In one embodiment a method for removing critical materials from various industrial processes and waste streams can be performed using specifically designed membranes. FIG. 15 is a flow chart 500 of a membrane-based embodiment method for critical material removal involving several essential steps:

Step 501 involves selecting and if necessary, step 502, modifying a membrane 502. A suitable membrane material, or a combination thereof, is selected based on the specific critical material to be removed. Surface modification techniques, such as functionalization, coating, or nanoparticle embedding, are applied to enhance membrane selectivity and efficiency. These modifications provide specific binding sites or chemical affinities for the target critical material.

Step 503 involves preparing a feed solution. A feed solution containing the critical material is prepared. This solution can be sourced from various industrial processes, waste streams, or mining operations.

Step 504 is the membrane separation process. The feed solution is introduced to the modified membrane. During the separation process, the critical material selectively adsorbs onto or permeates through the membrane, while unwanted impurities and components are rejected or pass through the membrane.

Ste 505 involves collecting critical materials. The captured critical material is collected and recovered from the membrane using appropriate techniques, such as elution, backwashing, or regeneration. The choice of recovery method depends on the specific nature of the material and membrane configuration.

Step 506 involves regenerating membranes. The membrane can be regenerated for reuse in subsequent separation cycles, if necessary. This regeneration process reduces operational costs and environmental impact.

Membranes separation can have several advantages. These advantages include but are not limited to exceptional selectivity and efficiency in capturing critical materials, minimization of waste generation and environmental impact, applicability to a wide range of critical materials and feed solutions, and potential for continuous and scalable operations.

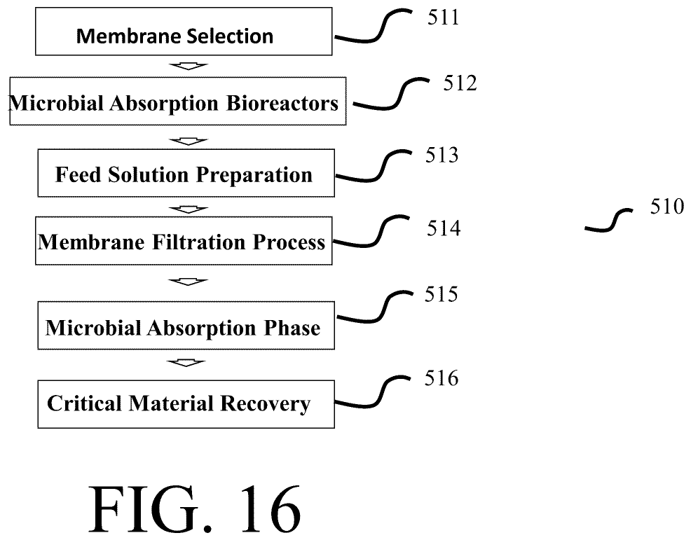

In one embodiment, membrane removal can be combined with microbial absorption to more effectively remove multiple critical materials form complex waste waters a shown in FIG. 16. The integrated membrane-microbial system for removing multiple critical materials can comprises several components and steps 511.

Step 511 involves selecting and if necessary, modifying a membrane. A suitable membrane or a combination of membranes is carefully selected based on the critical materials targeted for removal and the characteristics of the wastewater stream. The membranes may be modified or functionalized to enhance their selectivity and compatibility with the target materials.

Step 512 involves using microbial absorption bioreactors. Bioreactors containing specially selected microbial cultures are integrated into the wastewater treatment system. These microorganisms are tailored to selectively absorb and accumulate specific critical materials.

Step 513 involves preparing a feed solution. Complex wastewater streams containing multiple critical materials are prepared and introduced into the treatment system. These wastewater sources may include industrial effluents, mining wastewater, or other complex matrices.

Step 514 involves filtering using membranes. The wastewater is first subjected to membrane filtration, where the membranes effectively separate larger particles, organic matter, and unwanted impurities from the critical materials.

Step 515 involves a microbial absorption phase. The partially treated wastewater is then directed to the microbial absorption bioreactors. The microbial cultures selectively absorb and accumulate the targeted critical materials while leaving other components unaffected.

Step 516 involves recovering critical materials. Following microbial absorption, the enriched microbial biomass containing the critical materials is separated from the wastewater. Various techniques, such as biomass harvesting or bioreactor regeneration, can be employed to recover the absorbed materials.

Although the embodiments of the present disclosure and their advantages have been described in detail, various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

We claim:

1. A device comprising:
a. at least one pretreatment system, wherein the at least one pretreatment system removes at least one contaminant from a water stream;
b. at least one biosorption column; wherein the biosorption column adsorbs at least one metal from the water stream;
c. at least one thermal dewatering system, wherein the at least one thermal dewatering system removes at least a portion of the water from the water stream;
d. at least one chemical precipitation system where the chemical precipitation system removes at least one metal that was removed from the water stream using the at least one biosorption column.

2. A system comprising:
a. at least one pretreatment system, wherein the at least one pretreatment system removes at least one contaminant from a water stream;
b. at least one biosorption column; wherein the biosorption column adsorbs at least one metal from the water stream;
c. at least one thermal dewatering system, wherein the at least one thermal dewatering system removes at least a portion of the water from the water stream;
d. at least one chemical precipitation system where the chemical precipitation system removes at least one metal that was removed from the water stream using the at least one biosorption column; and
e. at least one control panel that runs the at least one biosorption column and the at least one chemical precipitation system in a coordinated manner.

3. A water treatment method to remove at least one metal comprising:
a. introducing a water stream into a device;
b. removing at least one contaminant from the water stream using a pretreatment system connected to the device;
c. removing at least one metal from the water stream using biosorption;
d. removing at least a portion of the water from the water stream using a thermal dewatering system; and
e. precipitating out the at least one metal removed from the water stream using biosorption using a chemical precipitation method.
